(19) United States
(12) Patent Application Publication
(10) Pub. No.: US 2016/0305309 A1
(43) Pub. Date: Oct. 20, 2016

(54) COOLING APPARATUS FOR INTERNAL COMBUSTION ENGINE

(71) Applicant: TOYOTA JIDOSHA KABUSHIKI KAISHA, Toyota-shi (JP)

(72) Inventor: Daishi TAKAHASHI, Kanagawa-ken (JP)

(73) Assignee: TOYOTA JIDOSHA KABUSHIKI KAISHA, Toyota-shi (JP)

(21) Appl. No.: 15/053,068

(22) Filed: Feb. 25, 2016

(30) Foreign Application Priority Data
Apr. 17, 2015 (JP) 2015-085080

(51) Int. Cl. F01P 7/14; F02F 1/14; F01P 11/14

(52) U.S. Cl. CPC F01P 7/14; F01P 11/14; F02F 1/14; F01P 2025/13; F01P 2025/30

(57) ABSTRACT

The cooling apparatus includes two cooling water circulation system in which the temperatures of the cooling water are different. A low-temperature cooling water circulation system includes an LT radiator that is disposed partway along a circulation circuit and that performs heat exchange between low-temperature cooling water and external air, a temperature sensor that detects the external air temperature, and an adjustment apparatus that adjusts an amount of low-temperature cooling water that is introduced into the LT radiator. The control apparatus adjusts the adjustment apparatus so that the temperature of the low-temperature cooling water approaches a target water temperature, and when the external air temperature is higher than the target water temperature, corrects the target water temperature to a value that is greater than or equal to the external air temperature.

### TECHNICAL FIELD

The present invention relates to a cooling apparatus for an internal combustion engine.

### BACKGROUND

A water cooling-type cooling apparatus for maintaining a cylinder head and a cylinder block at a suitable temperature is provided in an internal combustion engine. The cooling apparatus includes a cooling water circulation system that circulates cooling water between a radiator and a cooling water channel formed in a cylinder head or a cylinder block.

In Japanese Patent Laid-Open No. 2006-112344, technology is disclosed for reducing friction loss without decreasing anti-knocking performance in a cooling apparatus equipped with such kind of a cooling water circulation system. According to this technology, more particularly, a target cooling water temperature is set to a comparatively high temperature when the intake air temperature is comparatively low, and the target cooling water temperature is set to a comparatively low temperature when the intake air temperature is comparatively high. By this means, it is attempted to reduce friction loss when the intake air temperature is comparatively low, and also suppress a decrease in anti-knocking performance when the intake air temperature is comparatively high.

### SUMMARY

In this connection, some cooling apparatuses for an internal combustion engine include two cooling water circulation systems for which the temperatures are different. In such cooling apparatuses, the cooling water temperatures of the two cooling water circulation systems can be separately adjusted. Among such cooling apparatuses, there are also cooling apparatuses in which the temperature of cooling water that circulates through a low-temperature cooling water circulation system is set to a low temperature of, for example, 40° C. In such cooling apparatuses, depending on the environmental conditions, there is a risk that the external air temperature will be higher than a target water temperature for the low-temperature cooling water. In such a case, if control is performed on the premise that the external air temperature is lower than the target water temperature for the low-temperature cooling water, low-temperature cooling water will be introduced into the radiator irrespective of the fact that the temperature of the low-temperature cooling water cannot be brought close to the target water temperature from a high temperature side, and there is a risk that an unintended increase in the water temperature and wasteful driving of the water pump or the like will occur due to unnecessary heat reception.

The present invention has been made in view of the above described problem, and an object of the present invention is to provide a cooling apparatus for an internal combustion engine that, in an internal combustion engine equipped with two cooling water circulation systems for which the temperatures are different, can suppress an increase in a water temperature and consumption of electric power due to unnecessary heat reception from a radiator of a low-temperature cooling water circulation system.

In accomplishing the above object, according to a first aspect of the present invention, there is provided a cooling apparatus for an internal combustion engine, the apparatus comprising:

a low-temperature cooling water circulation system that is one of two cooling water circulation systems in which temperatures of cooling water are different, and that includes a low-temperature cooling water channel formed in the internal combustion engine and that causes low-temperature cooling water to circulate in the low-temperature cooling water channel through a circulation circuit;

a high-temperature cooling water circulation system that is one of the two cooling water circulation systems, and that includes a high-temperature cooling water channel formed in the internal combustion engine and that causes high-temperature cooling water to circulate in the high-temperature cooling water channel; and

a control apparatus to control operation of the low-temperature cooling water circulation system,

the low-temperature cooling water circulation system comprising:

an external air temperature sensor to detect an external air temperature,

a radiator that is disposed partway along the circulation circuit and that performs heat exchange between low-temperature cooling water and external air and

an adjustment apparatus to adjust an amount of low-temperature cooling water introduced into the radiator;

the control apparatus being configured to:

adjust the adjustment apparatus so that a temperature of the low-temperature cooling water approaches a target water temperature and

in a case where the external air temperature is higher than the target water temperature, correct the target water temperature to a value that is greater than or equal to the external air temperature.

According to a second aspect of the present invention, there is provided the cooling apparatus for an internal combustion engine according to the first aspect, wherein the control apparatus is configured to, in a case where the external air temperature is higher than the target water temperature, perform a correction that adds a differential value between the target water temperature and the external air temperature to the target water temperature.

According to a third aspect of the present invention, there is provided the cooling apparatus for an internal combustion engine according to the first aspect, wherein:

the adjustment apparatus comprises:

a bypass passage that bypasses the radiator from the circulation circuit and

a flow rate adjustment apparatus to adjust a ratio between a flow rate of cooling water that flows to the bypass passage and a flow rate of low-temperature cooling water that flows to the radiator; and

the control apparatus is configured to, in a case where the temperature of the low-temperature cooling water is less than or equal to the target water temperature, adjust the flow rate adjustment apparatus so as to decrease a proportion of the flow rate of the low-temperature cooling water that flows to the radiator in comparison to a case where the temperature of the low-temperature cooling water is higher than the target water temperature.

According to a fourth aspect of the present invention, there is provided the cooling apparatus for an internal combustion engine according to the third aspect, wherein:

the adjustment apparatus further comprises an electric water pump that is disposed partway along the circulation circuit and that causes low-temperature cooling water to circulate; and

the control apparatus is configured to restrict driving of the electric water pump in a case where the external air temperature is higher than the target water temperature.

According to a fifth aspect of the present invention, there is provided the cooling apparatus for an internal combustion engine according to the first aspect, wherein:

the adjustment apparatus comprises an electric water pump that is disposed partway along the circulation circuit and that causes low-temperature cooling water to circulate; and

the control apparatus is configured to, in a case where the temperature of the low-temperature cooling water is less than or equal to the target water temperature, reduce an amount of water that is fed by the electric water pump in comparison to a case where the temperature of the low-temperature cooling water is higher than the target water temperature.

According to a sixth aspect of the present invention, there is provided the cooling apparatus for an internal combustion engine according to the first aspect, wherein the low-temperature cooling water channel is a channel that is formed around an intake port formed in a cylinder head of the internal combustion engine.

In accomplishing the above object, according to an seventh aspect of the present invention, there is provided a cooling apparatus for an internal combustion engine, the apparatus comprising:

a low-temperature cooling water circulation system that is one of two cooling water circulation systems in which temperatures of cooling water are different, and that includes a low-temperature cooling water channel formed in the internal combustion engine and that causes low-temperature cooling water to circulate in the low-temperature cooling water channel through a circulation circuit;

a high-temperature cooling water circulation system that is one of the two cooling water circulation systems, and that includes a high-temperature cooling water channel formed in the internal combustion engine and that causes high-temperature cooling water to circulate in the high-temperature cooling water channel; and

a control apparatus to control operation of the low-temperature cooling water circulation system,

the low-temperature cooling water circulation system comprising:

an external air temperature sensor to detect an external air temperature,

a radiator that is disposed partway along the circulation circuit and that performs heat exchange between low-temperature cooling water and external air and

an adjustment apparatus to adjust an amount of low-temperature cooling water that is introduced into the radiator;

the adjustment apparatus comprising:

a bypass passage that bypasses the radiator from the circulation circuit and

a flow rate adjustment apparatus to adjust a ratio between a flow rate of cooling water that flows to the bypass passage and a flow rate of low-temperature cooling water that flows to the radiator;

the control apparatus being configured to adjust the flow rate adjustment apparatus to decrease a proportion of the flow rate of the low-temperature cooling water that flows to the radiator in a case where the temperature of the low-temperature cooling water is less than or equal to the external air temperature.

According to an eighth aspect of the present invention, there is provided the cooling apparatus for an internal combustion engine according to the seventh aspect, wherein

the adjustment apparatus comprises an electric water pump that is disposed partway along the circulation circuit and that causes low-temperature cooling water to circulate; and

the control apparatus is configured to reduce an amount of water that is fed by the electric water pump in a case where the temperature of the low-temperature cooling water is less than or equal to the external air temperature.

According to a ninth aspect of the present invention, there is provided the cooling apparatus for an internal combustion engine according to the seventh aspect, wherein the low-temperature cooling water channel is a channel that is formed around an intake port formed in a cylinder head of the internal combustion engine.

According to the first aspect of the present invention, in a case where the external air temperature is higher than the target water temperature, the target water temperature is corrected to a value that is greater than or equal to the external air temperature. If the external air temperature is higher than the target water temperature for low-temperature cooling water, the temperature of the low-temperature cooling water cannot be decreased from a high temperature side to the target water temperature. Therefore, according to the present invention, in a case where the external air temperature is higher than the target water temperature, the occurrence of a situation in which low-temperature cooling water is introduced into the radiator irrespective of the fact that the temperature of the low-temperature cooling water cannot be brought close to the target water temperature can be suppressed, and an unintended increase in the water temperature or wasteful power consumption by an adjustment apparatus due to unnecessary heat reception can be effectively suppressed.

According to the second aspect of the present invention, in a case where the external air temperature is higher than the target water temperature, the target water temperature is corrected to the value of the external air temperature. Therefore, a correction amount can be kept to a minimum and an increase in the temperature of the low-temperature cooling water can be suppressed.

According to the third aspect of the present invention, since the proportion of the flow rate of low-temperature cooling water that flows to the radiator is decreased in a case where the temperature of the low-temperature cooling water is lower than the external air temperature, unnecessary heat reception from the radiator can be suppressed.

According to the fourth aspect of the present invention, driving of an electric water pump is restricted in a case where the temperature of low-temperature cooling water is lower than the external air temperature. In a situation in which the temperature of low-temperature cooling water cannot be cooled to the target water temperature, the electric water pump does not contribute to cooling of the temperature of the low-temperature cooling water even if the electric water pump is driven. Therefore, according to the present invention, wasteful driving of the electric water pump can be suppressed to thereby suppress a deterioration in the fuel consumption.

According to the fifth aspect of the present invention, since the amount of water that is fed by the electric water pump is reduced when the temperature of the low-temperature cooling water is lower than the external air temperature, it is possible to suppress unnecessary heat reception from the radiator and also suppress a deterioration in fuel consumption.

According to the sixth aspect of the present invention, since the occurrence of a situation in which low-temperature cooling water that flows through a low-temperature cooling water channel that is formed around an intake port receives heat from the radiator can be suppressed, a decrease in anti-knocking performance or anti-pre-ignition performance can be suppressed.

According to the seventh aspect of the present invention, in a case where the temperature of the low-temperature cooling water cannot be cooled by means of the radiator, the flow rate adjustment apparatus is adjusted and the proportion of the flow rate of the low-temperature cooling water that flows to the radiator is decreased. Therefore, according to the present invention, unnecessary heat reception from the radiator can be suppressed.

According to the eighth aspect of the present invention, the amount of water that is fed by the electric water pump is reduced in a case where the temperature of the low-temperature cooling water cannot be cooled by the radiator. Therefore, according to the present invention, unnecessary heat reception from the radiator can be suppressed and wasteful driving of the electric water pump can also be suppressed to prevent a deterioration in fuel consumption.

According to the ninth aspect of the present invention, since the occurrence of a situation in which low-temperature cooling water that flows through a low-temperature cooling water channel that is formed around an intake port receives heat from the radiator can be suppressed, a decrease in anti-knocking performance or anti-pre-ignition performance can be suppressed.

### BRIEF DESCRIPTION OF THE DRAWINGS

FIG. 1 is a view illustrating the configuration of a cooling apparatus according to the embodiments;

FIG. 2 is a flowchart illustrating a control flow of LT flow rate control executed in a first embodiment;

FIG. 3 is a view illustrating a map of LT target water temperatures stored in a memory of the control apparatus;

FIG. 4 is a time chart illustrating an example of changes in various state quantities in a case where the external air temperature exceeds a target LT water temperature in the cooling apparatus of the first embodiment;

FIG. 5 is a flowchart illustrating a control flow of correction control executed in the first embodiment;

FIG. 6 is a view illustrating changes in a correction amount with respect to the external air temperature;

FIG. 7 is a view illustrating a modification of changes in the correction amount with respect to the external air temperature;

FIG. 8 is a flowchart illustrating a control flow of LT flow rate control executed in a second embodiment;

FIG. 9 is a view illustrating a map of the drive duty of an electric water pump that is stored in the control apparatus memory;

FIG. 10 is a view illustrating a modification of the configuration of the cooling apparatus according to the embodiments;

FIG. 11 is a flowchart illustrating a control flow of bypass control that is executed by the control apparatus in the first embodiment; and

FIG. 12 is a view illustrating the relation between the degree of opening of a three-way valve and a temperature difference between the external air temperature and an LT water temperature.

### DETAILED DESCRIPTION

Embodiments of the present invention are described hereunder with reference to the accompanying drawings. However, it is to be understood that even when the number, quantity, amount, range or other numerical attribute of an element is mentioned in the following description of the embodiments, the present invention is not limited to the mentioned numerical attribute unless it is expressly stated or theoretically defined. Further, structures or steps or the like described in conjunction with the following embodiments are not necessarily essential to the present invention unless expressly stated or theoretically defined.

### First Embodiment

A first embodiment of the present invention will be described referring to the drawings.

### [Configuration of First Embodiment]

An internal combustion engine of the present embodiment is a water-cooled engine (hereunder, referred to as simply “engine”) that is cooled by cooling water. The cooling water for cooling the engine is circulated between the engine and a radiator by a cooling water circulation system. The cooling water is supplied to both a cylinder block and a cylinder head of the engine.

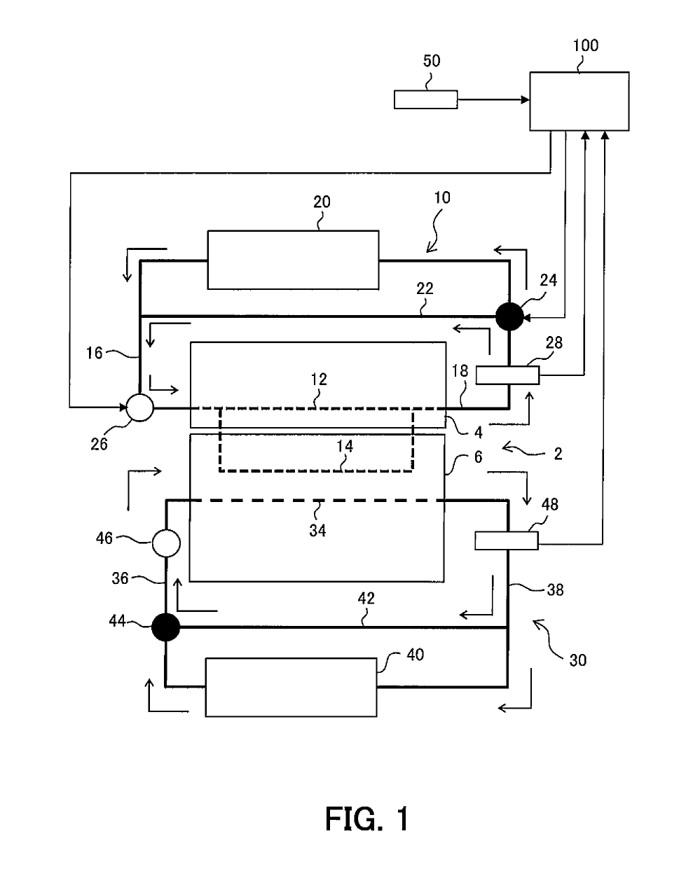

FIG. 1 is a view illustrating the configuration of a cooling apparatus of the present embodiment. The cooling apparatus of the present embodiment includes two cooling water circulation systems 10 and 30 that supply cooling water to an engine 2. Supply of cooling water is performed with respect to both of a cylinder block 6 and a cylinder head 4 of the engine 2. Each of the two cooling water circulation systems 10 and 30 is an independent closed loop, and each of the cooling water circulation systems 10 and 30 can vary the temperature of the cooling water that is circulated. Hereunder, the cooling water circulation system 10 in which cooling water of a comparatively low temperature (hereinafter, referred to as “LT cooling water”) circulates is referred to as “LT cooling water circulation system”, and the cooling water circulation system 30 in which cooling water of a comparatively high temperature (hereinafter, referred to as “HT cooling water”) circulates is referred to as “HT cooling water circulation system”. Note that, “LT” is an abbreviation of “low temperature” and “HT” is an abbreviation of “high temperature”.

The LT cooling water circulation system 10 includes an in-head LT cooling water channel 12 that is formed inside the cylinder head 4, and an in-block LT cooling water channel 14 that is formed inside the cylinder block 6. The in-head LT cooling water channel 12 is provided in the vicinity of an intake port, and the in-block LT cooling water channel 14 is provided so as to surround a portion in which intake air is particularly liable to collide against an upper portion of the cylinder. The sensitivity of the temperature of the intake port and an intake valve and also a wall surface temperature of the upper portion of the cylinder with respect to knocking and pre-ignition is high. Hence, by cooling the aforementioned parts in a concentrated manner by means of the in-head LT cooling water channel 12 and the in-block LT cooling water channel 14, the occurrence of knocking or pre-ignition in a high-load region can be effectively suppressed. Note that, the in-head LT cooling water channel 12 and the in-block LT cooling water channel 14 are connected through an opening formed in a mating surface between the cylinder head 4 and the cylinder block 6.

A cooling water inlet and a cooling water outlet that communicate with the in-head LT cooling water channel 12 are formed in the cylinder head 4. The cooling water inlet of the cylinder head 4 is connected to a cooling water outlet of an LT radiator 20 by a cooling water introduction pipe 16, and the cooling water outlet of the cylinder head 4 is connected to a cooling water inlet of the LT radiator 20 by a cooling water discharge pipe 18. The cooling water introduction pipe 16 and the cooling water discharge pipe 18 are connected by a bypass pipe 22 that bypasses the LT radiator 20.

A three-way valve 24 is provided at a branching portion at which the bypass pipe 22 branches from the cooling water discharge pipe 18. An electric water pump 26 for circulating cooling water is provided downstream of a merging portion with the bypass pipe 22 in the cooling water introduction pipe 16. The amount of water that is fed by the electric water pump 26 can be arbitrarily changed by adjusting the output of a motor. A temperature sensor 28 for measuring the temperature of cooling water that passes through the inside of the engine 2 (hereunder, referred to as “LT water temperature “ethwL””) is installed on the upstream side of the three-way valve 24 in the cooling water discharge pipe 18.

The HT cooling water circulation system 30 includes an in-block HT cooling water channel 34 that is formed inside the cylinder block 6. In contrast to the aforementioned in-block LT cooling water channel 14 that is a locally provided cooling water channel, the in-block HT cooling water channel 34 is a major portion of a water jacket that surrounds the periphery of a cylinder.

A cooling water inlet and a cooling water outlet that communicate with the in-block HT cooling water channel 34 are formed in the cylinder block 6. The cooling water inlet of the cylinder block 6 is connected to a cooling water outlet of a HT radiator 40 by a cooling water introduction pipe 36, and the cooling water outlet of the cylinder block 6 is connected to a cooling water inlet of the HT radiator 40 by a cooling water discharge pipe 38. The cooling water introduction pipe 36 and the cooling water discharge pipe 38 are connected by a bypass pipe 42 that bypasses the HT radiator 40. A thermostat 44 is provided at a merging portion at which the bypass pipe 42 merges with the cooling water introduction pipe 36. A mechanical water pump 46 for circulating cooling water is provided downstream of the thermostat 44 in the cooling water introduction pipe 36. The water pump 46 is connected through a belt to a crank shaft of the engine 2. A temperature sensor 48 for measuring the temperature of cooling water that passes through the inside of the engine 2 (hereunder, referred to as “HT water temperature “ethwH””) is installed upstream of a branching portion with the bypass pipe 42 in the cooling water discharge pipe 38.

As described above, in the HT cooling water circulation system 30, because the water pump 46 is driven by the engine 2, cooling water is always circulating while the engine 2 is operating. The temperature of the cooling water circulating through the HT cooling water circulation system 30 is automatically adjusted by the thermostat 44. On the other hand, in the LT cooling water circulation system 10, since the electric water pump 26 is used, cooling water can be circulated or caused to stop circulating regardless of whether or not the engine 2 is operating. Further, in the LT cooling water circulation system 10, the flow rate of circulating cooling water can be controlled by means of a drive duty applied to the electric water pump 26. In addition, the temperature of cooling water circulating through the LT cooling water circulation system 10 can be actively adjusted by actuating the three-way valve 24 or the electric water pump 26.

Actuation of the three-way valve 24 and the electric water pump 26 of the LT cooling water circulation system 10 is performed by a control apparatus 100. The control apparatus 100 is a control apparatus of the cooling apparatus and at the same time is also a control apparatus that controls operation of the engine 2. The control apparatus 100 is configured to include as a main constituent an ECU (electronic control unit) that includes at least an input/output interface, a memory and a central processing unit CPU. The input/output interface is provided in order to take in sensor signals from various sensors that are installed in the engine 2 or the vehicle in which the engine 2 is mounted, and to also output actuating signals to various actuators that the engine 2 includes. The sensors from which the control apparatus 100 takes in signals include, in addition to the above described temperature sensors 28 and 48, various sensors such as a temperature sensor 50 for measuring the external air temperature. The actuators to which the control apparatus 100 outputs actuating signals include, in addition to the above described three-way valve 24, thermostat 44 and electric water pump 26, various actuators for controlling operation of the engine 2. Various control programs and maps and the like for controlling the engine 2 are stored in the memory. The CPU reads out a control program or the like from the memory and executes the control program or the like, and generates actuating signals for the various actuators based on sensor signals that were taken in. The control apparatus 100 functions as an adjustment apparatus that actuates the electric water pump 26 to adjust the flow rate of the LT cooling water (hereunder, referred to as “LT flow rate”). Further, by actuating the three-way valve 24 to control the proportion of cooling water that bypasses the LT radiator 20, the control apparatus 100 functions as an adjustment apparatus that adjusts the temperature and flow rate of cooling water that flows through the in-head LT cooling water channel 12 or the in-block LT cooling water channel 14.

### [Operations in First Embodiment]

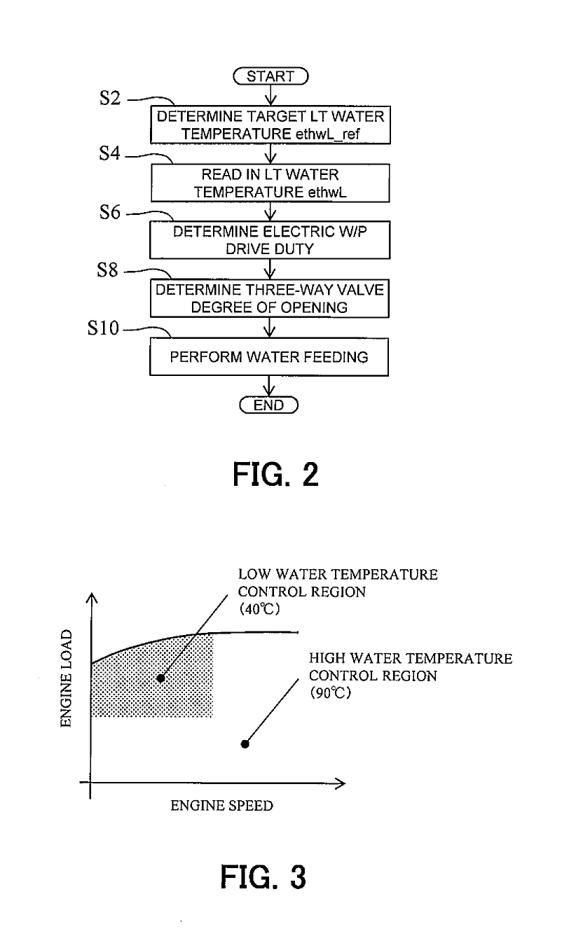

First, LT flow rate control that is the basic control of the cooling apparatus of the first embodiment will be described. The control apparatus 100 controls the LT flow rate in order to appropriately cool principal portions of the cylinder head 4 and the cylinder block 6, respectively. FIG. 2 is a flowchart illustrating the control flow of LT flow rate control that is performed by the control apparatus 100. The control apparatus 100 repeatedly executes a routine represented by this control flow at predetermined control periods that correspond to the clock speed of the ECU.

First, the control apparatus 100 calculates the target temperature of cooling water that flows through the in-head LT cooling water channel 12 or the in-block LT cooling water channel 14 (hereunder, referred to as “target LT water temperature “ethwL_ref””) (step S2). The control apparatus 100 determines a cooling water temperature that is effective for suppressing knocking and pre-ignition as the target LT water temperature. FIG. 3 is a view illustrating a map of the target LT water temperature that is stored in the memory of the control apparatus 100. As shown in the map in FIG. 3, the target LT water temperature is associated with the operating state of the engine 2 that is determined by the engine speed and engine load. According to the example shown in the map in FIG. 3, a low-speed and high-load region in which knocking or pre-ignition is liable to occur is associated with a target LT water temperature of 40° C. as a low water temperature control region, and regions other than the low-speed and high-load region are associated with a target LT water temperature of 90° C. as a high water temperature control region.

Next, the control apparatus 100 reads in the LT water temperature “ethwL” measured by the temperature sensor 28 (step S4). The control apparatus then determines the drive duty of the electric water pump 26 (step S6). In this case, first, the control apparatus 100 determines a requested LT flow rate that is a requested value of the LT flow rate based on the target LT water temperature that is determined in step S2. In a map that is stored in the memory of the control apparatus 100, the requested LT flow rate is associated with operating states of the engine 2 that are determined by the engine speed and engine load. The control apparatus 100 determines the drive duty of the electric water pump 26 based on the requested LT flow rate that is determined.

Next, the control apparatus 100 determines the degree of opening of the three-way valve 24 (step S8). In this case, if the LT water temperature “ethwL” that is read in by the control apparatus 100 in step S4 exceeds the target LT water temperature “ethwL_ref” that is determined in step S2, the control apparatus 100 determines the degree of opening of the three-way valve 24 so that the total amount of cooling water will flow into the LT radiator 20. Further, if the LT water temperature “ethwL” is less than or equal to the target LT water temperature “ethwL_ref”, the control apparatus 100 determines the degree of opening of the three-way valve 24 so that the total amount of cooling water will bypass the LT radiator 20.

Finally, the control apparatus 100 actuates the three-way valve 24 in accordance with the degree of opening that is determined in step S8, and also actuates the electric water pump 26 in accordance with the drive duty that is determined in step S6 to thereby cause cooling water to flow through the in-head LT cooling water channel 12 and the in-block LT cooling water channel 14 (step S10). By this means, the LT flow rate changes and the principal portions of each of the cylinder head 4 and the cylinder block 6 are cooled to an appropriate temperature.

Thus, according to the above described LT flow rate control, the temperature of the LT cooling water can be brought close to the target LT water temperature. Note that, in the above described LT flow rate control, the degree of opening of the three-way valve 24 is determined so that the circulation destination of the LT cooling water is completely switched depending on whether or not the LT water temperature “ethwL” exceeds the target LT water temperature “ethwL_ref”. However, a method of determining the degree of opening of the three-way valve 24 is not limited thereto, and in a case where the LT water temperature “ethwL” is less than or equal to the target LT water temperature “ethwL_ref” it is sufficient to determine the degree of opening of the three-way valve 24 so that the flow rate of the LT cooling water that flows to the LT radiator 20 decreases in comparison to a case where the LT water temperature “ethwL” exceeds the target LT water temperature “ethwL_ref”.

Next, correction control of the target LT water temperature that is characteristic control of the cooling apparatus of the first embodiment will be described. As described above, to suppress knocking and pre-ignition, the control apparatus 100 sometimes sets the target LT water temperature to a value of a comparatively low temperature (for example 40° C.). Further, under a high temperature environment (for example 50° C.), the external air temperature is sometimes higher than the target LT water temperature. According to the LT flow rate control under such a condition, in a case where the LT water temperature that is measured by the temperature sensor 28 is lower than the external air temperature, although the situation is one in which the LT cooling water cannot be cooled, even in such a case LT cooling water is introduced into the LT radiator. As a result, the LT cooling water actively receives heat from the LT radiator 20, and consequently a temperature difference between the LT water temperature and the target LT water temperature increases further.

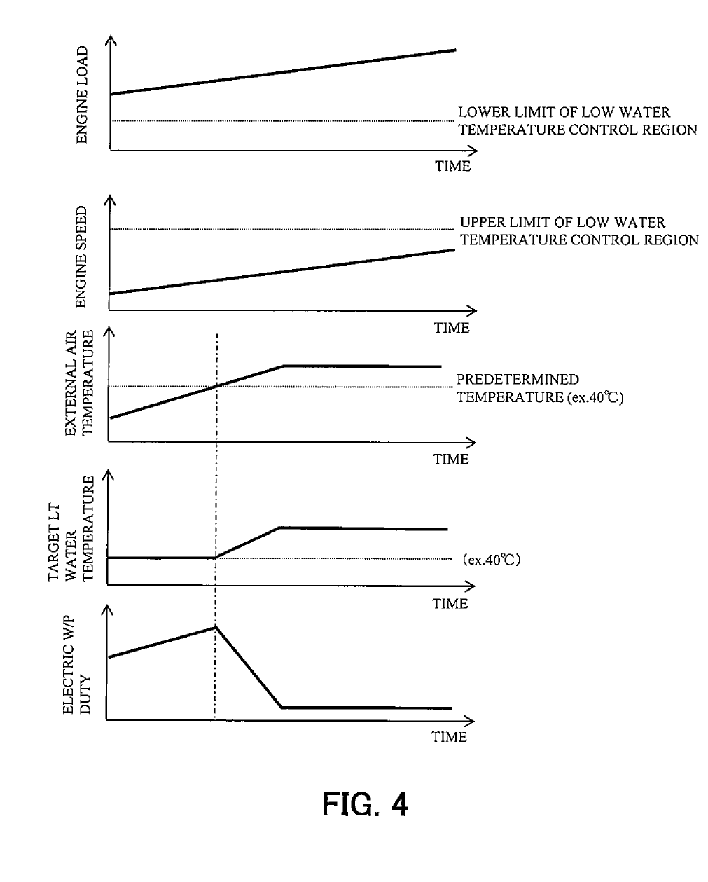

Therefore, in the cooling apparatus of the present embodiment, a configuration is adopted in which, in a case where the external air temperature is higher than the target LT water temperature, the target LT water temperature is corrected to a value that is equal to or higher than the external air temperature. FIG. 4 is a time chart illustrating one example of changes in various state quantities in a case where the external air temperature exceeds the target LT water temperature in the cooling apparatus of the first embodiment. In the example shown in FIG. 4, in a case where the operating state of the engine 2 belongs to the low water temperature control region, if the external air temperature exceeds the target LT water temperature (for example 40° C.), the target LT water temperature is corrected to a value on a high temperature side as the external air temperature increases. According to this correction control, in a case where the external air temperature is higher than the target LT water temperature, the LT water temperature becomes a value that is less than or equal to the corrected target LT water temperature. By this means, since the total amount of LT cooling water bypasses the LT radiator 20, an increase in the temperature of the LT cooling water can be effectively suppressed.

Note that, if a situation in which the electric water pump 26 is driven irrespective of the fact that the LT water temperature cannot be cooled to the target LT water temperature is continued, a deterioration in fuel consumption that is due to wasteful power consumption will become a problem. Therefore, as shown in FIG. 4, during a period in which the target LT water temperature is being corrected, it is preferable to actively decrease the drive duty of the electric water pump 26. By this means, it is possible to suppress a deterioration in fuel consumption.

### [Specific Processing in First Embodiment]

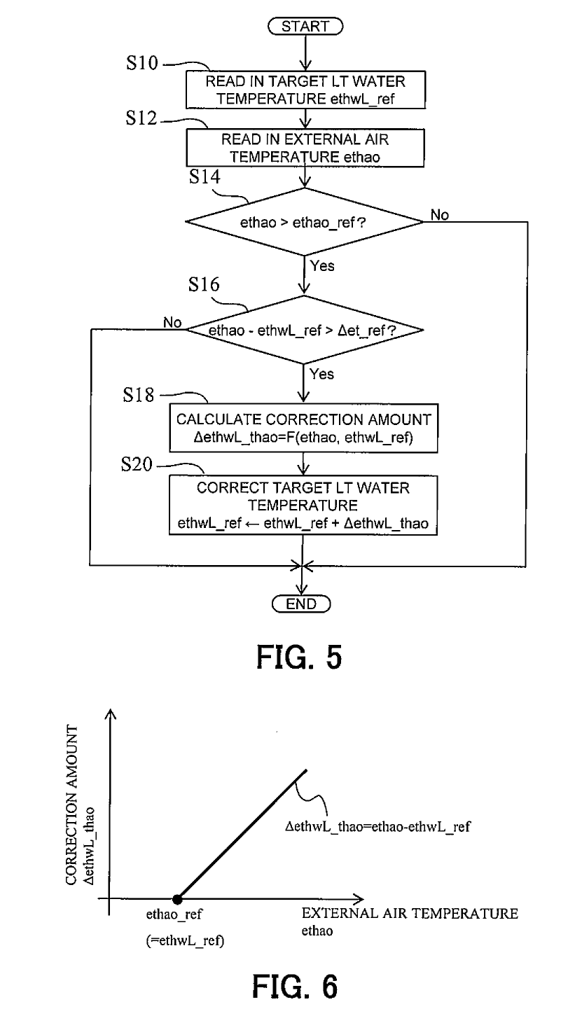

Next, specific processing of the correction control that is executed in the cooling apparatus of the present embodiment will be described. The control apparatus 100 controls a correction amount of the target LT water temperature based on the external air temperature. FIG. 5 is a flowchart illustrating a control flow of the correction control executed by the control apparatus 100. The control apparatus 100 repeatedly executes a routine represented by this flow at predetermined control periods that correspond to the clock speed of the ECU.

First, the control apparatus 100 reads in the target LT water temperature “ethwL_ref” that is determined by the processing in the aforementioned step S2 (step S10). Next, the control apparatus 100 reads in an external air temperature “ethao” measured by the temperature sensor 50 (step S12).

The control apparatus 100 then determines whether or not the external air temperature “ethao” that is read in by the processing in step S12 is higher than a predetermined temperature “ethao_ref” (step S14). The predetermined temperature “ethao_ref” is a threshold value of the external air temperature for determining whether or not to perform correction of the target LT water temperature, and for example is set to the same value as the target LT water temperature (ethao_ref=40° C.).

If the result determined by the processing in the aforementioned step S14 is that the relation ethao>ethao_ref is not established, the control apparatus 100 determines that it is not necessary to perform correction of the target LT water temperature and therefore swiftly ends the present routine. In contrast, if the result determined by the processing in the aforementioned step S14 is that the relation ethao>ethao_ref is established, the control apparatus 100 determines that it is necessary to perform correction of the target LT water temperature, and transitions to the next step.

In the next step, the control apparatus 100 determines whether or not a temperature difference “ethao-ethwL_ref” between the external air temperature “ethao” that is read in by the processing in step S12 and the target LT water temperature “ethwL_ref” that is read in by the processing in step S10 is greater than a predetermined value “Δet_ref” (step S16). The predetermined value “Δet_ref” is a threshold value of the temperature difference “ethao-ethwL_ref” for determining whether or not to perform correction of the target LT water temperature, and for example the predetermined value Δet_ref is set to 0.

If the result determined by the processing in the aforementioned step S16 is that the relation (ethao-ethwL_ref)>Δet_ref is not established, the control apparatus 100 determines that it is not necessary to perform correction of the target LT water temperature because the external air temperature is less than or equal to the target LT water temperature, and therefore swiftly ends the present routine. In contrast, if the result determined by the processing in the aforementioned step S16 is that the relation (ethao-ethwL ret)>Δet_ref is established, the control apparatus 100 determines that it is necessary to perform correction of the target LT water temperature because the external air temperature is higher than the target LT water temperature, and transitions to the next step. IN the next step, the control apparatus 100 calculates a correction amount “ΔethwL_thao” using the following equation (1) (step S18).

ΔethwL_thao=ethao-ethwL_ref (1)

As shown in the above equation (1), the correction amount “ΔethwL_thao” is expressed by a function using the external air temperature and the target LT water temperature. FIG. 6 is a view illustrating changes in the correction amount with respect to the external air temperature. The relation of the correction amount with respect to the external air temperature that is shown in FIG. 6 is a relation that shows the relation in the above equation (1), and shows that the correction amount “ΔethwL_thao” is 0 when the external air temperature “ethao” matches the predetermined temperature “ethao_ref”, that is, when the external air temperature “ethao” matches the target LT water temperature “ethwL_ref”. Further, when the external air temperature “ethao” becomes higher than the predetermined temperature “ethao_ref” (=target LT water temperature ethwL_ref), the correction amount “ΔethwL_thao” increases in proportion thereto.

Next, the control apparatus 100 corrects the target LT water temperature (step S20). In this step, a value obtained by adding the correction amount “ΔethwL_thao” calculated in the aforementioned step S18 to the target LT water temperature “ethwL_ref” that is read in by the control apparatus 100 in the aforementioned step S10 is calculated as the corrected target LT water temperature. According to this processing, the corrected target LT water temperature becomes equal to the external air temperature. The corrected target LT water temperature that is calculated is used in the LT flow rate control. By this means, in a case where the external air temperature is higher than the target LT water temperature, introduction of LT cooling water to the LT radiator is restricted, and it is therefore possible to suppress an increase in the LT water temperature.

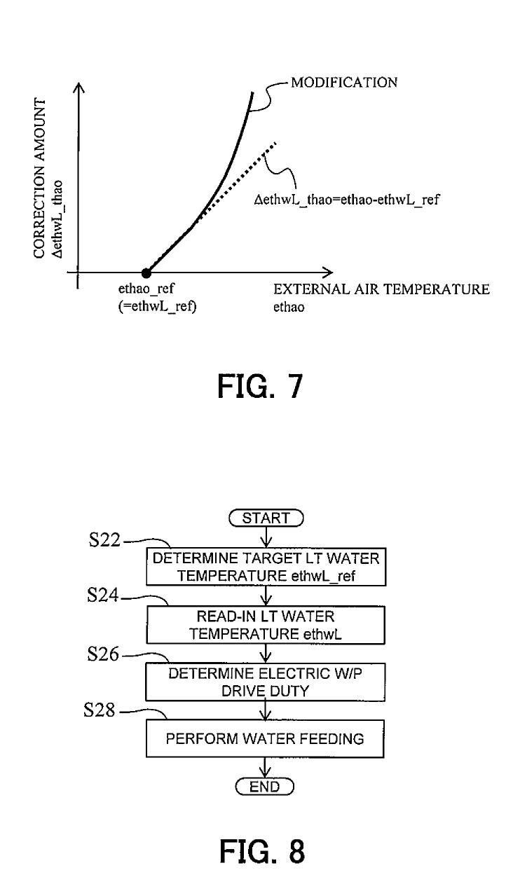

In this connection, in the cooling apparatus of the first embodiment that is described above, a configuration is adopted so that, in a case where the external air temperature is higher than the target LT water temperature, the target LT water temperature is corrected so as to become equal to the external air temperature. However, correction of the target LT temperature is not limited thereto, and a configuration may also be adopted so as to correct the target LT water temperature so as to become a value that is greater than or equal to the external air temperature within an allowable range from the viewpoint of suppressing knocking and pre-ignition. FIG. 7 is a view illustrating a modification of changes in the correction amount with respect to the external air temperature. In the relation of the correction amount to the external air temperature illustrated in FIG. 7, the correction amount increases in a quadratic functional manner as the external air temperature increases. According to this correction, the higher that the external air temperature is, the larger the value that the target LT water temperature is corrected to relative to the external air temperature, and consequently driving of the electric water pump 26 can be further suppressed. Note that this similarly applies with regard to a cooling apparatus of a second embodiment that is described later.

Further, although in the cooling apparatus of the first embodiment that is described above a configuration is adopted that, during a period in which the external air temperature is higher than the target LT water temperature, actively decreases the drive duty of the electric water pump 26 to restrict driving thereof, a configuration may also be adopted that stops driving of the electric water pump 26 within an allowable range from the viewpoint of a request to remove heat from within the in-head LT cooling water channel 12 or the in-block LT cooling water channel 14.

Note that, in the cooling apparatus of the first embodiment that is described above, the in-head LT cooling water channel 12 or the in-block LT cooling water channel 14 corresponds to “low-temperature cooling water channel” of the first aspect of the present invention, the cooling water introduction pipe 16 or cooling water discharge pipe 18 corresponds to “circulation circuit” of the first aspect of the present invention, the LT cooling water circulation system 10 corresponds to “low-temperature cooling water circulation system” of the first aspect of the present invention, the in-block HT cooling water channel 34 corresponds to “high-temperature cooling water channel” of the first aspect of the present invention, the HT cooling water circulation system 30 corresponds to “high-temperature cooling water circulation system” of the first aspect of the present invention, the LT radiator 20 corresponds to “radiator” of the first aspect of the present invention, the temperature sensor 50 corresponds to “external air temperature sensor” of the first aspect of the present invention, the bypass pipe 22 and the three-way valve 24 correspond to “adjustment apparatus” of the first aspect of the present invention, the control apparatus 100 corresponds to “control apparatus” of the first aspect of the present invention, and the target LT water temperature corresponds to “target water temperature” of the first aspect of the present invention.

Further, in the cooling apparatus of the first embodiment that is described above, the bypass pipe 22 corresponds to “bypass passage” of the third aspect of the present invention, and the three-way valve 24 corresponds to “flow rate adjustment apparatus” of the third aspect of the present invention.

### Second Embodiment

A second embodiment of the present invention will now be described referring to the drawings.

### [Feature of Second Embodiment]

In the cooling apparatus of the first embodiment, a configuration is adopted in which, in the LT flow rate control, the target LT water temperature is determined based on the engine speed and engine load of the engine 2, and the degree of opening of the three-way valve 24 is then determined. In contrast, the cooling apparatus of the second embodiment differs from the cooling apparatus of the first embodiment in that the LT flow rate is determined by means of the drive duty of the electric water pump 26 based on the LT water temperature and target LT water temperature. The LT flow rate control of the cooling apparatus of the second embodiment is described in detail hereunder in accordance with a flowchart.

FIG. 8 is a flowchart illustrating a control flow of LT flow rate control performed by the control apparatus 100. The control apparatus 100 repeatedly executes a routine represented by this flow at predetermined control periods that correspond to the clock speed of the ECU.

First, the control apparatus 100 determines the target LT water temperature “ethwL_ref” (step S22). Specifically, in this case the same processing as in the above described step S2 is executed. Next, the control apparatus 100 reads in the LT water temperature “ethwL” that is measured by the temperature sensor 28 (step S24). In this case, specifically, the processing as in the above described step S4 is executed.

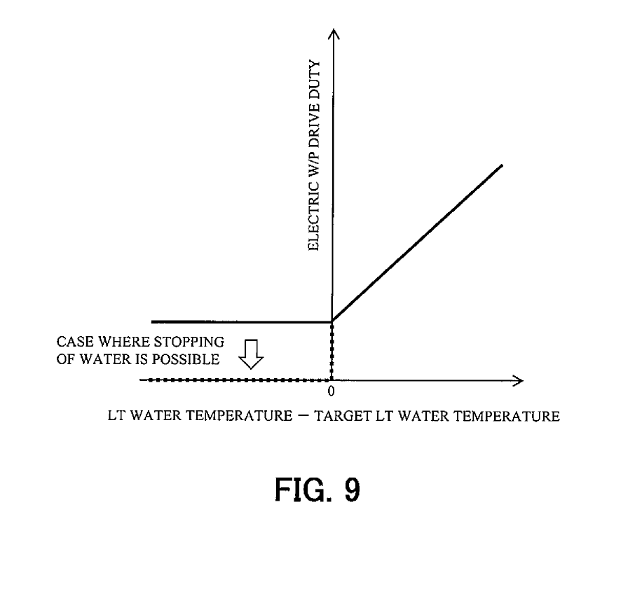

Subsequently, the control apparatus 100 determines the drive duty of the electric water pump 26 based on the target LT water temperature “ethwL_ref” determined in step S22 and the LT water temperature “ethwL” that is read in step S24 (step S26). FIG. 9 is a view illustrating a map of the drive duty of the electric water pump 26 that is stored in the memory of the control apparatus 100. As shown in the map in FIG. 9, the drive duty of the electric water pump 26 is associated with a water temperature difference “ethwL-ethwL_ref” between the LT water temperature “ethwL” and the target LT water temperature “ethwL_ref”. In the example shown in the map, the drive duty of the electric water pump 26 is associated with the water temperature difference “ethwL-ethwL_ref” so that the drive duty increases as the water temperature difference “ethwL-ethwL_ref” becomes greater than 0. Further, in a case where the water temperature difference “ethwL-ethwL_ref” is less than or equal to 0, the value of the drive duty is associated so that the LT flow rate becomes the required minimum flow rate. Note that, with regard to the required minimum LT flow rate, temperature measurement can be performed by means of the temperature sensor 28, and a value can be used that is determined based on conditions such as being a value at which cooling water does not boil within the in-head LT cooling water channel 12 or the in-block LT cooling water channel 14. For example, in a case where it is possible to stop circulation of the LT cooling water after taking into account these conditions, as shown by a chain line in FIG. 9, the drive duty in a case where the water temperature difference “ethwL-ethwL_ref” becomes less than or equal to 0 can also be determined as 0%.

Finally, the control apparatus 100 actuates the electric water pump 26 in accordance with the drive duty determined in step S26 to cause water to flow through the in-head LT cooling water channel 12 and the in-block LT cooling water channel 14 (step S28). By this means, the LT flow rate changes and the principal portions of each of the cylinder head 4 and the cylinder block 6 are cooled to an appropriate temperature.

Here, when the correction control illustrated in FIG. 5 is performed, if the external air temperature is higher than the target LT water temperature, the target LT water temperature is corrected to a value that is equal to or higher than the external air temperature. According to this correction control, when the external air temperature is higher than the target LT water temperature, a temperature difference between the LT water temperature and the corrected target LT water temperature is less than or equal to 0. By this means, wasteful driving of the electric water pump is suppressed, and hence a deterioration in fuel consumption is also suppressed.

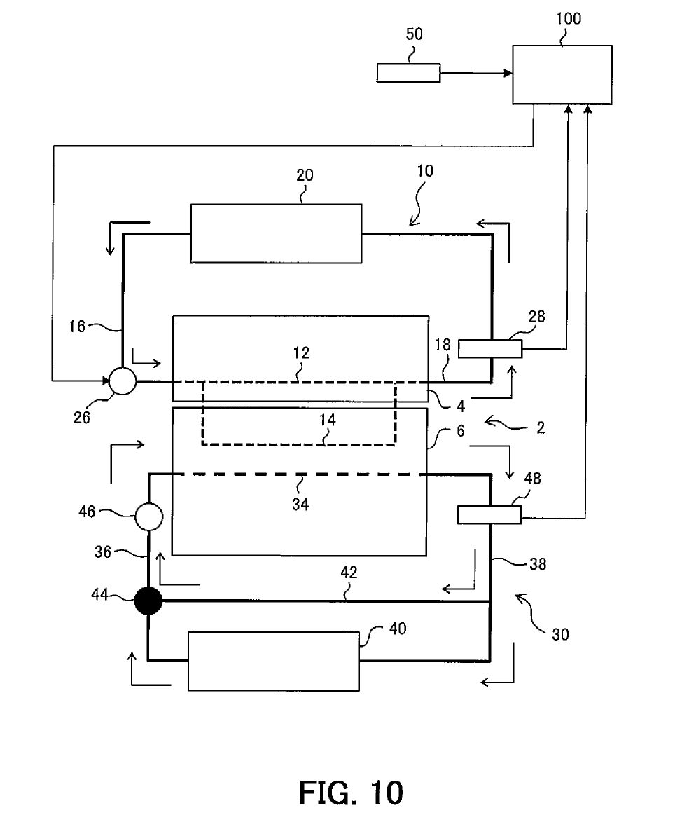

In this connection, although in the cooling apparatus of the second embodiment that is described above the LT cooling water circulation system 10 includes the bypass pipe 22, the bypass pipe 22 is not an essential constituent thereof. For example, as shown in FIG. 10, a configuration can also be adopted that does not include components that correspond to the bypass pipe 22 and the three-way valve 24 in the configuration shown in FIG. 1.

Further, in the cooling apparatus of the second embodiment that is described above, the drive duty of the electric water pump 26 is determined in accordance with a temperature difference between the LT water temperature and the target LT water temperature. However, control for determining the drive duty is not limited thereto, and another method may also be adopted as long as the drive duty is determined so that the LT water temperature is brought close to the target LT water temperature. For example, a method may be adopted in which for each routine it is determined whether or not the relation that the LT water temperature>target LT water temperature is established, and if the relation that the LT water temperature>target LT water temperature is established, the drive duty is increased by one step, while if the relation that the LT water temperature>target LT water temperature is not established, the drive duty is decreased by one step.

Note that, in the cooling apparatus of the second embodiment that is described above, the in-head LT cooling water channel 12 or in-block LT cooling water channel 14 corresponds to “low-temperature cooling water channel” of the first aspect of the present invention, the cooling water introduction pipe 16 or cooling water discharge pipe 18 corresponds to “circulation circuit” of the first aspect of the present invention, the LT cooling water circulation system 10 corresponds to “low-temperature cooling water circulation system” of the first aspect of the present invention, the in-block HT cooling water channel 34 corresponds to “high-temperature cooling water channel” of the first aspect of the present invention, the HT cooling water circulation system 30 corresponds to “high-temperature cooling water circulation system” of the first aspect of the present invention, the LT radiator 20 corresponds to “radiator” of the first aspect of the present invention, the temperature sensor 50 corresponds to “external air temperature sensor” of the first aspect of the present invention, the electric water pump 26 corresponds to “adjustment apparatus” of the first aspect of the present invention, the control apparatus 100 corresponds to “control apparatus” of the first aspect of the present invention and the target LT water temperature corresponds to “target water temperature” of the first aspect of the present invention.

### Third Embodiment

A third embodiment of the present invention will now be described referring to the drawings.

### [Feature of Third Embodiment]

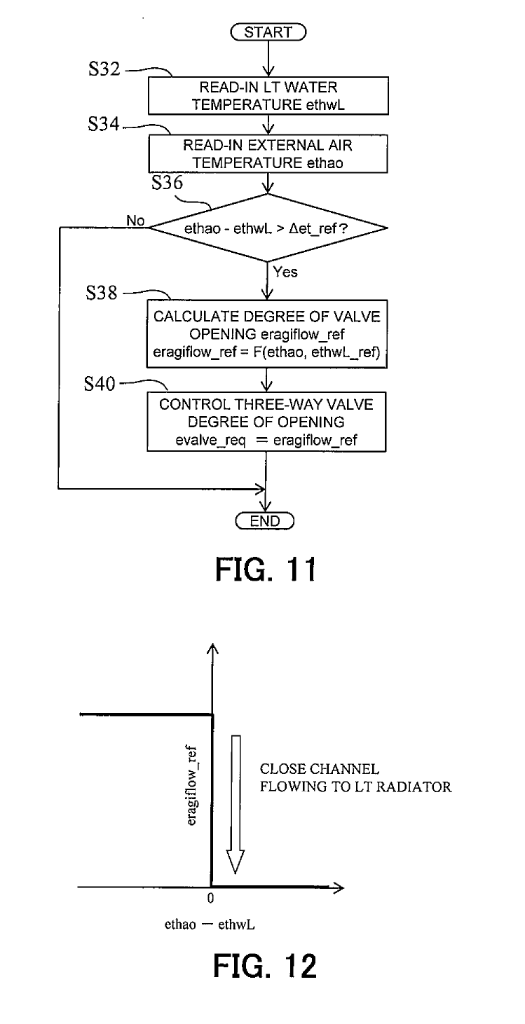

The cooling apparatus of the third embodiment can be realized by using the hardware configuration illustrated in FIG. 1 that is described above, and causing the control apparatus 100 to execute the routine shown in FIG. 11 that is described later. In a case where the LT water temperature is less than or equal to the external air temperature, the LT cooling water is heated by heat exchange with the LT radiator 20. Therefore, in the cooling apparatus of the first embodiment that is described above, a configuration is adopted so that in a case where the external air temperature is higher than the target LT water temperature, the target LT water temperature is corrected to the same value as the external air temperature. By this means, even in a case where the LT water temperature is less than or equal to the external air temperature, a situation in which the LT water temperature becomes higher than the target LT water temperature is avoided, and hence the amount of LT cooling water that is introduced into the LT radiator 20 is restricted.

In contrast, a feature of the cooling apparatus of the third embodiment is control that actively changes the degree of opening of the three-way valve 24, instead of the correction control of the first embodiment. More specifically, in a case where the LT water temperature is less than or equal to the external air temperature, the cooling apparatus of the third embodiment executes bypass control that actively adjusts the degree of opening of the three-way valve 24 to cause the LT cooling water to circulate in a manner that bypasses the LT radiator 20. The bypass control is described in detail hereunder in accordance with a flowchart.

FIG. 11 is a flowchart illustrating a control flow of the bypass control executed by the control apparatus 100. The control apparatus 100 repeatedly executes a routine represented by this flow at predetermined control periods that correspond to the clock speed of the ECU. Note that the routine illustrated in FIG. 8 is executed in parallel with the routine of the LT flow rate control illustrated in FIG. 2.

First, the control apparatus 100 reads in the LT water temperature “ethwL” that is measured by the temperature sensor 28 (step S32). Next, the control apparatus 100 reads in the external air temperature “ethao” that is measured by the temperature sensor 50 (step S34).

Subsequently, the control apparatus 100 determines whether or not a temperature difference “ethao-ethwL” between the external air temperature “ethao” that is read in by the processing in step S34 and the LT water temperature “ethwL” that is read in by the processing in step S32 is greater than a predetermined value “Δet_ref” (step S36). The predetermined value “Δet_ref” is a threshold value of the temperature difference “ethao-ethwL_ref” for determining whether or not introduction of the LT cooling water to the LT radiator 20 should be restricted, and for example the predetermined value Δet_ref is set to 0.

If the result determined by the processing in the aforementioned step S36 is that the relation (ethao-ethwL)>Δet_ref is not established, the control apparatus 100 determines that it is not necessary to restrict introduction of the LT cooling water to the LT radiator 20 because the external air temperature is less than or equal to the LT water temperature. In this case, the control apparatus 100 maintains a degree of opening “eragiflow_ref” of the three-way valve 24 in a normal state in which the three-way valve 24 opens a channel on the LT radiator 20 side and swiftly ends the present routine. In contrast, if the result determined by the processing in the aforementioned step S36 is that the relation (ethao-ethwL)>Δet_ref is established, the control apparatus 100 determines that it is necessary to restrict introduction of the LT cooling water to the LT radiator 20 because the external air temperature is higher than the LT water temperature. In this case, the control apparatus 100 calculates the degree of opening “eragiflow_ref” of the three-way valve 24 in accordance with the temperature difference (ethao-ethwL) between the external air temperature and the LT water temperature (step S38).

FIG. 12 is a view illustrating the relation between the degree of opening of the three-way valve and the temperature difference between the external air temperature and the LT water temperature. As shown in FIG. 12, in a case where the temperature difference (ethao-ethwL) between the external air temperature and the LT water temperature is greater than or equal to 0, the degree of opening “eragiflow_ref” of the three-way valve 24 is set to a degree of opening such that the total amount of the LT cooling water bypasses the LT radiator 20.

Next, the control apparatus 100 controls the three-way valve 24 (step S40). In this case, the control apparatus 100 sets a requested degree of opening value “evalve_req” of the three-way valve 24 to the degree of opening “eragiflow_ref” calculated in the aforementioned step S26, and controls the three-way valve 24. According to this processing, introduction of the LT cooling water to the LT radiator 20 is stopped, and heating of the LT cooling water by the LT radiator 20 is thus suppressed.

In this connection, in the cooling apparatus of the third embodiment that is described above, a configuration is adopted in which the three-way valve 24 is adjusted as means for restricting the flow of the LT cooling water into the LT radiator 20. However, means for restricting the flow of the LT cooling water into the LT radiator 20 is not limited thereto, and for example instead of the control of the three-way valve 24, or in addition to the control of the three-way valve 24, the drive duty of the electric water pump 26 may be controlled so as to restrict the amount of water that is fed thereby or control may be performed so as to stop the driving of the electric water pump 26. In this case, since driving of the electric water pump 26 can also be suppressed, an increase in the temperature of the LT cooling water can be suppressed and, furthermore, a deterioration in fuel consumption can be suppressed.

In the cooling apparatus of the third embodiment that is described above, in a case where the temperature difference between the external air temperature and the LT water temperature is greater than or equal to 0, the degree of opening of the three-way valve 24 is set so that the total amount of the LT cooling water bypasses the LT radiator 20. However, setting of the degree of opening of the three-way valve 24 is not limited thereto, and it is sufficient to set the degree of opening of the three-way valve 24 so that a proportion of the flow rate that bypasses the LT radiator 20 is greater than in the case of a degree of opening when the temperature difference is less than 0. For example, the degree of opening of the three-way valve 24 may be set so as to increase the proportion of the flow rate that bypasses the LT radiator 20 as the temperature difference between the external air temperature and the LT water temperature increases.

Further, in the cooling apparatus of the third embodiment that is described above, a configuration is adopted that uses the electric water pump 26 as means for circulating the LT cooling water in the LT cooling water circulation system 10. However, the water pump may also be configured as a mechanical water pump that is connected via a belt to the crank shaft of the engine 2.

Note that, in the cooling apparatus of the third embodiment that is described above, the in-head LT cooling water channel 12 or the in-block LT cooling water channel 14 corresponds to “low-temperature cooling water channel” of the first aspect of the present invention, the cooling water introduction pipe 16 or the cooling water discharge pipe 18 corresponds to “circulation circuit” of the first aspect of the present invention, the LT cooling water circulation system 10 corresponds to “low-temperature cooling water circulation system” of the first aspect of the present invention, the in-block HT cooling water channel 34 corresponds to “high-temperature cooling water channel” of the first aspect of the present invention, the HT cooling water circulation system 30 corresponds to “high-temperature cooling water circulation system” of the first aspect of the present invention, the LT radiator 20 corresponds to “radiator” of the first aspect of the present invention, the temperature sensor 50 corresponds to “external air temperature sensor” of the first aspect of the present invention, the electric water pump 26 or the bypass pipe 22 and the three-way valve 24 correspond to “adjustment apparatus” of the first aspect of the present invention, and the control apparatus 100 corresponds to “control apparatus” of the first aspect of the present invention.

Further, in the cooling apparatus of the third embodiment that is described above, the bypass pipe 22 corresponds to “bypass passage” of the seventh aspect of the present invention, and the three-way valve 24 corresponds to “flow rate adjustment apparatus” of the seventh aspect of the present invention.

1. A cooling apparatus for an internal combustion engine, the apparatus comprising:
a low-temperature cooling water circulation system that is one of two cooling water circulation systems in which temperatures of cooling water are different, and that includes a low-temperature cooling water channel formed in the internal combustion engine and that causes low-temperature cooling water to circulate in the low-temperature cooling water channel through a circulation circuit;
a high-temperature cooling water circulation system that is one of the two cooling water circulation systems, and that includes a high-temperature cooling water channel formed in the internal combustion engine and that causes high-temperature cooling water to circulate in the high-temperature cooling water channel; and
a control apparatus to control operation of the low-temperature cooling water circulation system,
the low-temperature cooling water circulation system comprising:
an external air temperature sensor to detect an external air temperature,
a radiator that is disposed partway along the circulation circuit and that performs heat exchange between low-temperature cooling water and external air and
an adjustment apparatus to adjust an amount of low-temperature cooling water introduced into the radiator;
the control apparatus being configured to:
adjust the adjustment apparatus so that a temperature of the low-temperature cooling water approaches a target water temperature and
in a case where the external air temperature is higher than the target water temperature, correct the target water temperature to a value that is greater than or equal to the external air temperature.

2. The cooling apparatus for an internal combustion engine according to claim 1, wherein the control apparatus is configured to, in a case where the external air temperature is higher than the target water temperature, perform a correction that adds a differential value between the target water temperature and the external air temperature to the target water temperature.

3. The cooling apparatus for an internal combustion engine according to claim 1, wherein:
the adjustment apparatus comprises:
a bypass passage that bypasses the radiator from the circulation circuit and a flow rate adjustment apparatus to adjust a ratio between a flow rate of cooling water that flows to the bypass passage and a flow rate of low-temperature cooling water that flows to the radiator; and
the control apparatus is configured to, in a case where the temperature of the low-temperature cooling water is less than or equal to the target water temperature, adjust the flow rate adjustment apparatus so as to decrease a proportion of the flow rate of the low-temperature cooling water that flows to the radiator in comparison to a case where the temperature of the low-temperature cooling water is higher than the target water temperature.

4. The cooling apparatus for an internal combustion engine according to claim 3, wherein:
the adjustment apparatus further comprises an electric water pump that is disposed partway along the circulation circuit and that causes low-temperature cooling water to circulate; and
the control apparatus is configured to restrict driving of the electric water pump in a case where the external air temperature is higher than the target water temperature.

5. The cooling apparatus for an internal combustion engine according to claim 1, wherein:
the adjustment apparatus comprises an electric water pump that is disposed partway along the circulation circuit and that causes low-temperature cooling water to circulate; and
the control apparatus is configured to, in a case where the temperature of the low-temperature cooling water is less than or equal to the target water temperature, reduce an amount of water that is fed by the electric water pump in comparison to a case where the temperature of the low-temperature cooling water is higher than the target water temperature.

6. The cooling apparatus for an internal combustion engine according to claim 1, wherein the low-temperature cooling water channel is a channel that is formed around an intake port formed in a cylinder head of the internal combustion engine.

7. A cooling apparatus for an internal combustion engine, the apparatus comprising:
a low-temperature cooling water circulation system that is one of two cooling water circulation systems in which temperatures of cooling water are different, and that includes a low-temperature cooling water channel formed in the internal combustion engine and that causes low-temperature cooling water to circulate in the low-temperature cooling water channel through a circulation circuit;
a high-temperature cooling water circulation system that is one of the two cooling water circulation systems, and that includes a high-temperature cooling water channel formed in the internal combustion engine and that causes high-temperature cooling water to circulate in the high-temperature cooling water channel; and
a control apparatus to control operation of the low-temperature cooling water circulation system,
the low-temperature cooling water circulation system comprising:
an external air temperature sensor to detect an external air temperature,
a radiator that is disposed partway along the circulation circuit and that performs heat exchange between low-temperature cooling water and external air and
an adjustment apparatus to adjust an amount of low-temperature cooling water that is introduced into the radiator;
the adjustment apparatus comprising:
a bypass passage that bypasses the radiator from the circulation circuit and
a flow rate adjustment apparatus to adjust a ratio between a flow rate of cooling water that flows to the bypass passage and a flow rate of low-temperature cooling water that flows to the radiator;
the control apparatus being configured to adjust the flow rate adjustment apparatus to decrease a proportion of the flow rate of the low-temperature cooling water that flows to the radiator in a case where the temperature of the low-temperature cooling water is less than or equal to the external air temperature.

8. The cooling apparatus for an internal combustion engine according to claim 7, wherein
the adjustment apparatus comprises an electric water pump that is disposed partway along the circulation circuit and that causes low-temperature cooling water to circulate; and
the control apparatus is configured to reduce an amount of water that is fed by the electric water pump in a case where the temperature of the low-temperature cooling water is less than or equal to the external air temperature.

9. The cooling apparatus for an internal combustion engine according to claim 7, wherein the low-temperature cooling water channel is a channel that is formed around an intake port formed in a cylinder head of the internal combustion engine.
